(19) United States
(12) Patent Application Publication
(10) Pub. No.: US 2013/0021793 A1
(43) Pub. Date: Jan. 24, 2013

(54) RECYCLING LIGHT CAVITY WITH ENHANCED REFLECTIVITY

(71) Applicants: Scott M. Zimmerman, Basking Ridge, NJ (US); William R. Livesay, San Diego, CA (US); Richard L. Ross, Del Mar, CA (US)

(72) Inventors: Scott M. Zimmerman, Basking Ridge, NJ (US); William R. Livesay, San Diego, CA (US); Richard L. Ross, Del Mar, CA (US)

(21) Appl. No.: 13/554,441

(22) Filed: Jul. 20, 2012

Related U.S. Application Data
(60) Provisional application No. 61/572,821, filed on Jul. 22, 2011.

(51) Int. Cl. F21V 9/00

(52) U.S. Cl. 362/231

(57) ABSTRACT

The reflectivity of mixed color LEDs, for example, red, green, and blue LEDs, and the resulting efficiency of a mixed color recycling light cavity can be increased by over-coating each LED with a multi-layer thin film coating comprising a dichroic filter. The thin film, dichroic filter coatings transmit the light emitted by the LED and reflect the light emanating from the other colors within the cavity. By utilizing high efficiency dichroic coatings, the reflectivity of the LEDs to the alternate wavelengths of the light emitted by other LEDs in the cavity can be raised to over 90%. By increasing the reflectivity of the LEDs for other colors, the optical radiation absorbed by the LEDs is decreased, thereby lowering the operation temperature and junction temperature of the LEDS. Lowering the operation temperature and junction temperature of the LEDS contributes to more efficient operation of the LEDs improving Lumen/Watt performance.

REFERENCE TO PRIOR APPLICATION

This application claims the benefit of U.S. Provisional Patent Application Ser. No. 61/572,821, which was filed on Jul. 22, 2011, which is herein incorporated by reference.

### BACKGROUND OF THE INVENTION

Recycling light cavities incorporating light emitting diodes (LEDs) have been shown to be highly dependent on the reflectivity of the LEDs that they incorporate. LED manufacturers are primarily interested in obtaining high extraction efficiency, and not reflectivity, of the LEDs.

In a RGB type of cavity, the reflectivities of the LEDs are compromised by the fact that red, blue and green LEDs typically have lower reflectivities for wavelengths of other colors than is necessary. For example, an AlGaN red LED has very low reflectivity for blue and green light. As a result, recycling light cavities utilizing red, green and blue LEDs that these cavities have much lower extraction efficiency than cavities constructed with LEDs of all one color. Yet there are multiple applications in which color combining within a cavity leads to reduced package size and increased light throughput. This is especially true for mobile applications such as cellphone projectors, portable projectors, and light sources in which color balancing is required. These applications also require maximum efficiency as well.

Therefore, a need exists to increase reflectivity and output efficiency of recycling light cavities utilizing red, green and blue LEDs.

### SUMMARY OF THE INVENTION

In a mixed color recycling light cavity comprising, for example, red, green, and blue LEDs, the reflectivity of the LEDs and the resulting efficiency of the cavity can be dramatically increased. Light emitting diodes are typically optimized to obtain high extraction efficiency, not reflectivity. A method of obtaining high reflectivity and extraction efficiency for an LED is presented in U.S. Pat. No. 7,352,006, commonly assigned as the present application and herein incorporated by reference.

In a light recycling cavity as described in U.S. Pat. Nos. 6,869,206; 6,960,872; and 7,040,774; commonly assigned as the present patent application and herein incorporated by reference, the reflectivity of the LEDs plays a dominant role in the extraction efficiency and light output of the recycling light cavity. In U.S. Pat. Nos. 7,025,464; 7,048,385; and 7,431,463; commonly assigned as the present patent application and herein incorporated by reference, recycling light cavities contain LEDs with different emitting wavelengths.

In this type of cavity, the three colors are combined inside the cavity and can be further mixed and homogenized with a rod integrator light pipe affixed to the output of the cavity. This combination of colors inside one cavity has many advantages including small size and small etendue. In fact, the output area of the cavity is one third the size of the output area if the LEDs are arranged in a conventional planar array package.

However, in a mixed red, green, and blue cavity it is possible to achieve even higher reflectivity for alternate wavelengths of each LED. By over-coating each LED with a multi-layer thin film coating comprising a dichroic filter, coatings can be applied so as to transmit the light emitted by the LED and reflect the light emanating from the other colors within the cavity. For example, with a recycling light cavity comprising a red, green and blue LED, the red LED is coated with a long pass filter. This filter is optimally fully transparent for the red light emitted by the red LED and highly reflective of the light emitted by the blue and green LEDs. Similarly, the blue LED is coated with a short wave pass filter, which is transparent to the light emitted by the blue LED and highly reflective to the light emitted by the green and red LEDs. The green LED is coated with a narrow band pass filter, which is transparent to the light emitted by the green LED and is highly reflective to the light emitted by the blue and red LEDs. By utilizing high efficiency dichroic coatings, the reflectivity of the LEDs to the alternate wavelengths of the light emitted by other LEDs in the cavity can be raised to over 90%. This is significant because, for example, as mentioned previously, the red LED has very poor reflectivity (1 to 15%) for blue and green wavelengths. By raising the reflectivity for alternate wavelengths, the cavity efficiency can be raised from 50% in one case to over 80%, an increase of 60% in light output.

There are other benefits of applying these dichroic coatings to LEDs in a mixed color RGB recycling light cavity. By increasing the reflectivity of the LEDs for other colors, the optical radiation absorbed by the LEDs is decreased, thereby lowering the operation temperature and junction temperature of the LEDS. Lowering the operation temperature and junction temperature of the LEDS contributes to more efficient operation of the LEDs improving Lumen/Watt performance.

It is an embodiment of this invention that modification of the reflective properties of an LED for wavelengths substantially outside the emission band of the LED be used to enhance color combining both within a cavity and outside a cavity. Dichroic coatings, quantum crystal structures, quantum dot layer, graded index coatings, subwavelength coatings, and polarization dependent layers including but not limited to wire grid polarizers, reflective polarizers, and retardation films can modify the reflective nature of the LED. These layers can be formed either at the wafer level, chip and/or device level. In this manner, the efficiency of color combining for both unpolarized and polarized light sources can be enhanced both within a cavity and outside a cavity. These films can simultaneously enhance extraction efficiency from the LED based on reducing reflections within the LED itself for light generated within the LED. These advantages and further enhancements are shown in the detailed description of the invention below.

DESCRIPTION OF THE FIGURES

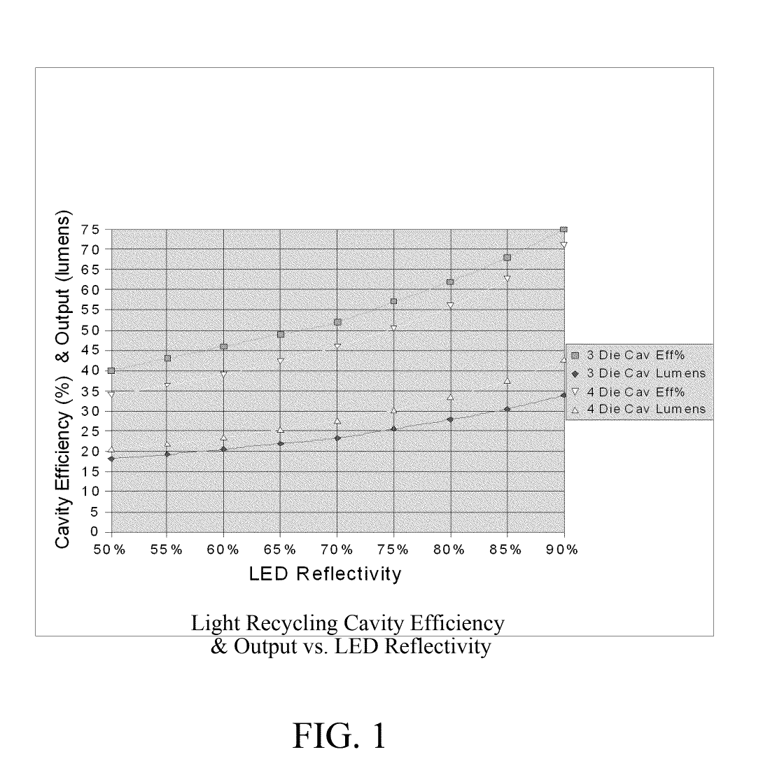

FIG. 1 is a graph showing recycling light cavity extraction efficiency as a function of reflectivity of the interior walls of the cavity.

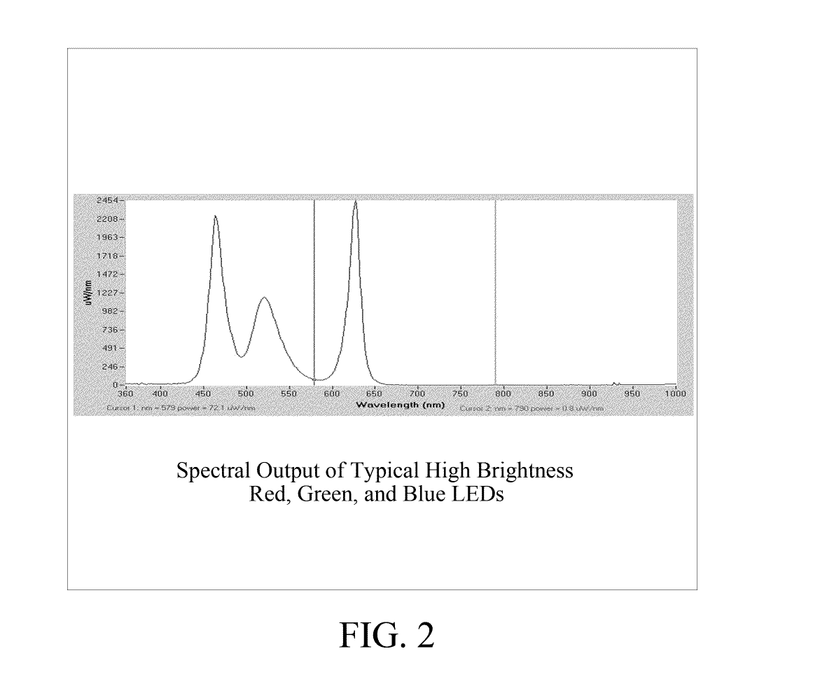

FIG. 2 is a graph showing the spectral output of typical high brightness red, green, and blue LEDs.

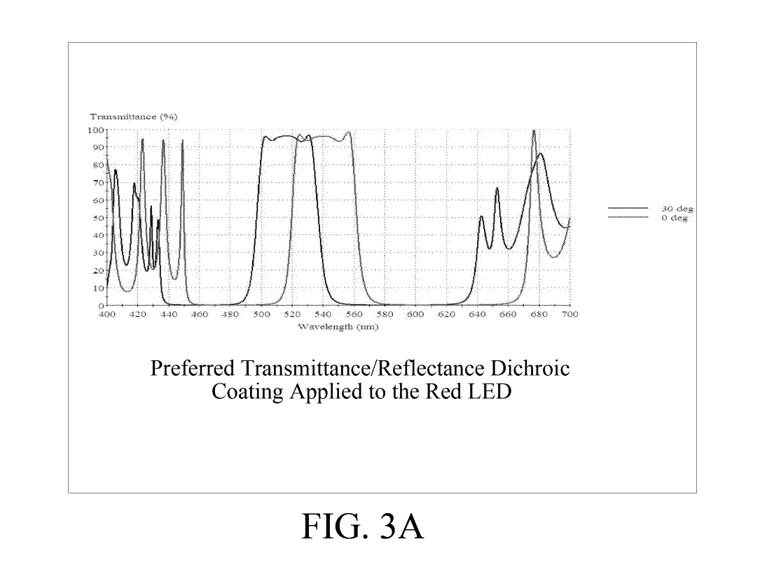

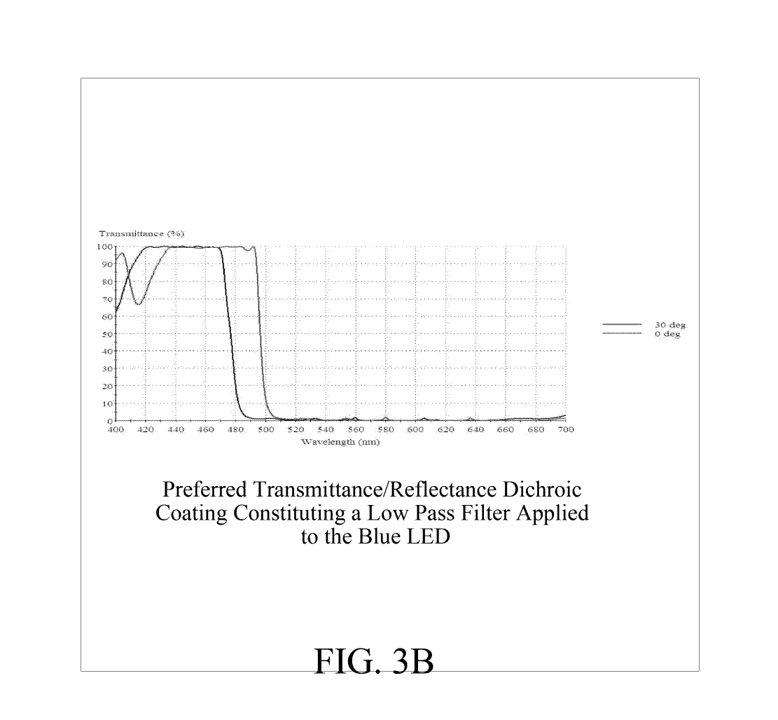

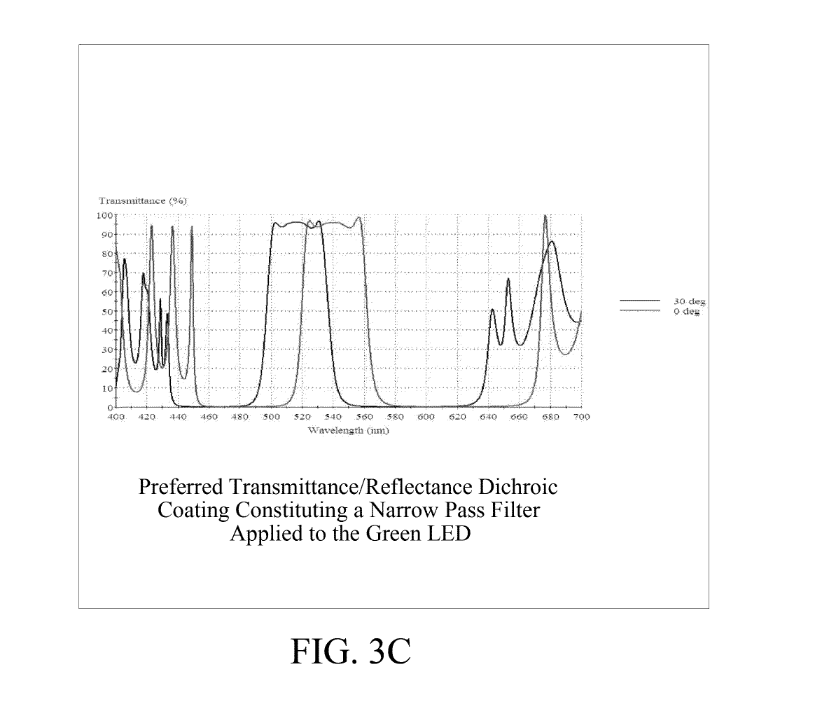

FIG. 3 shows the transmittance/reflectivity of dichroic coatings utilized herein to enhance the overall reflectivity of the light recycling cavity. FIG. 3A is a graph showing the preferred transmittance/reflectance dichroic coating applied to the red LED. FIG. 3B is a graph showing the preferred transmittance/reflectance dichroic coating constituting a low pass filter applied to the blue LED. FIG. 3C is a graph showing the preferred transmittance/reflectance dichroic coating constituting a narrow band pass filter applied to the green LED.

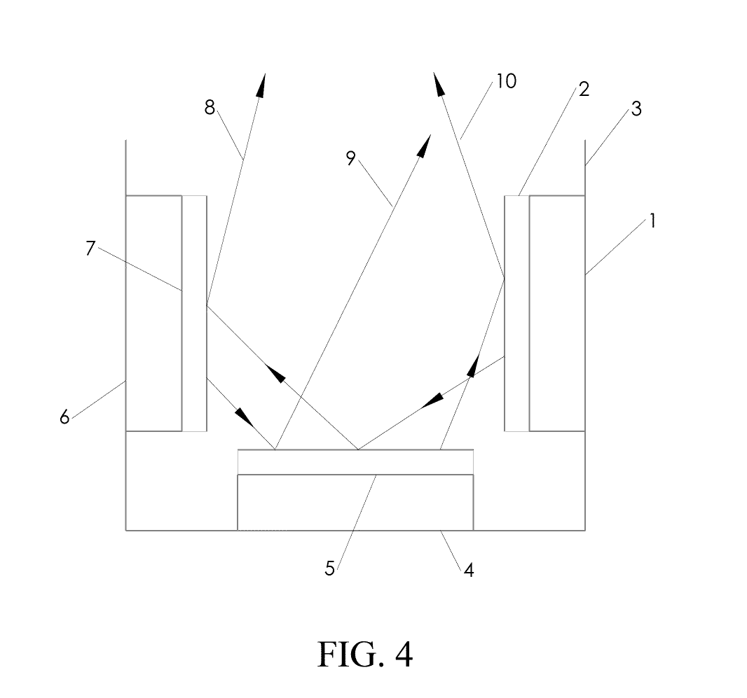

FIG. 4 shows a cross-section view of the light recycling cavity with dichroic coatings on the LEDs.

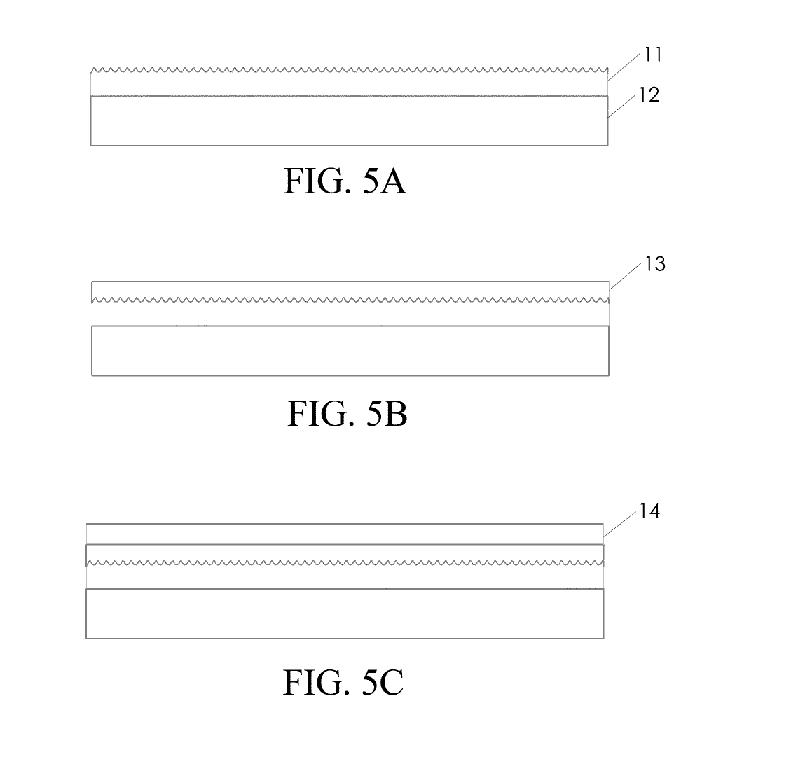

FIGS. 5A, 5B, and 5C shows a cross-section view of a LED wafer with roughened surface planarized by spin-on glass coating and dichroic applied.

FIG. 6 shows a cross-section view of a LED wafer with roughened surface planarized by spin-on glass coating and dichroic applied and spatially graded index of refraction induced by electron beam exposures.

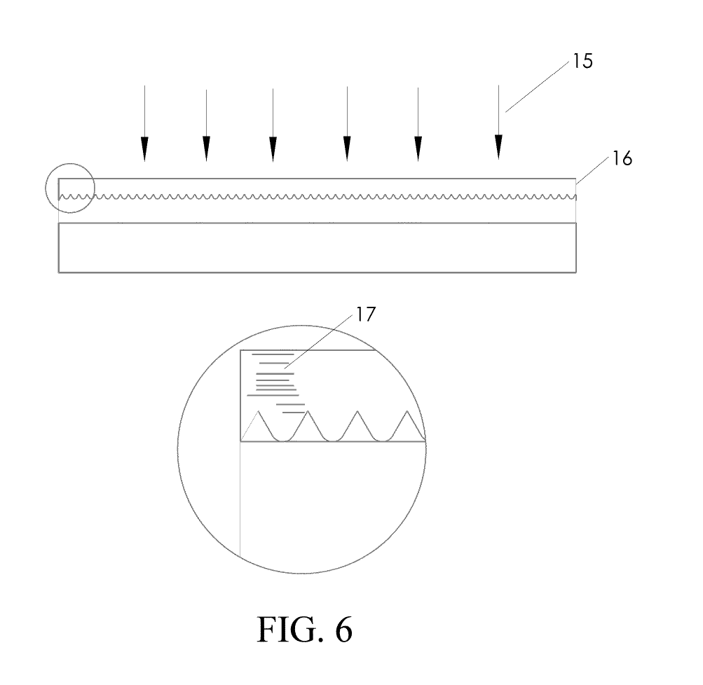

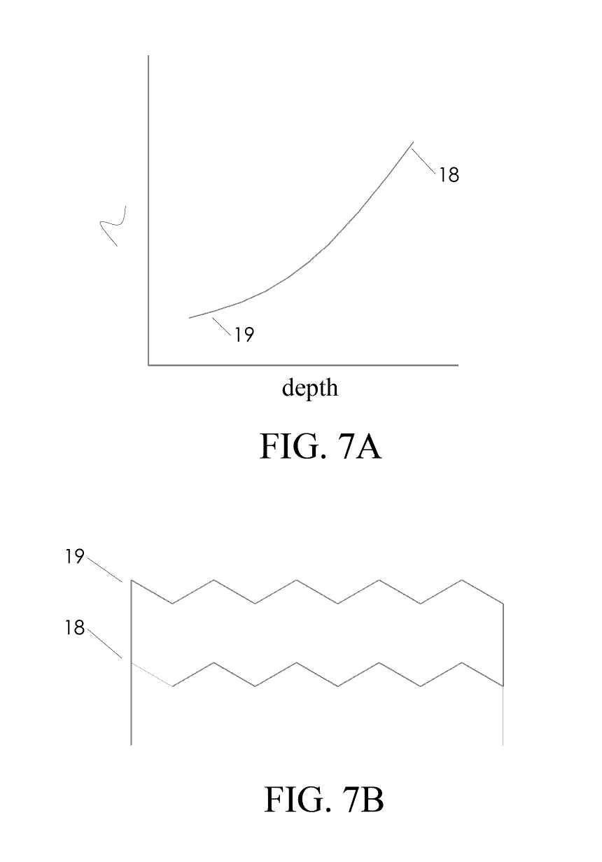

FIG. 7A is a graph and 7B is a cross-section view of a LED wafer with roughened and spatially graded index of refraction induced by electron beam in roughened surface.

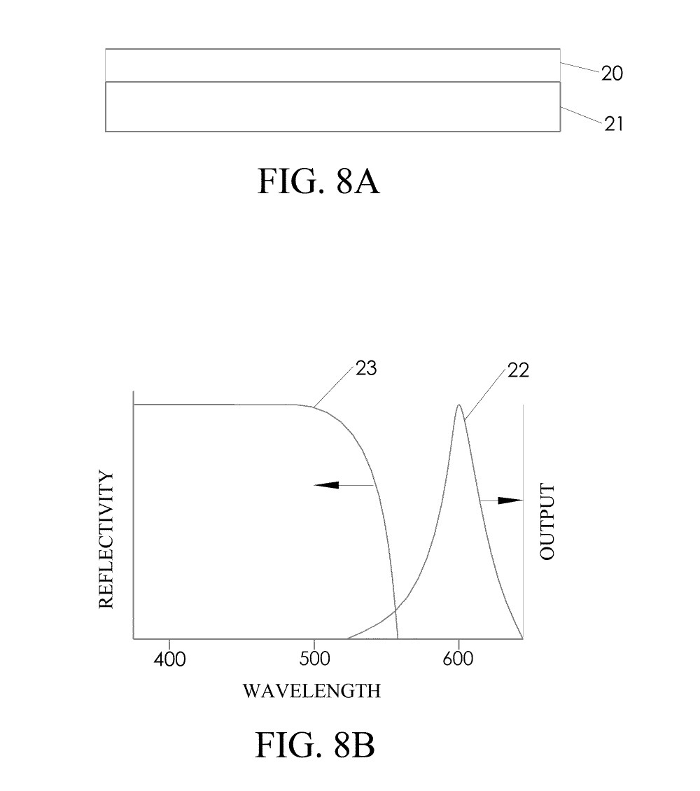

FIG. 8A is a cross-section view and 8B is a graph showing a LED with a wavelength dependent coating, which enhances reflectivity for wavelengths substantially different than the emission wavelengths of the LED.

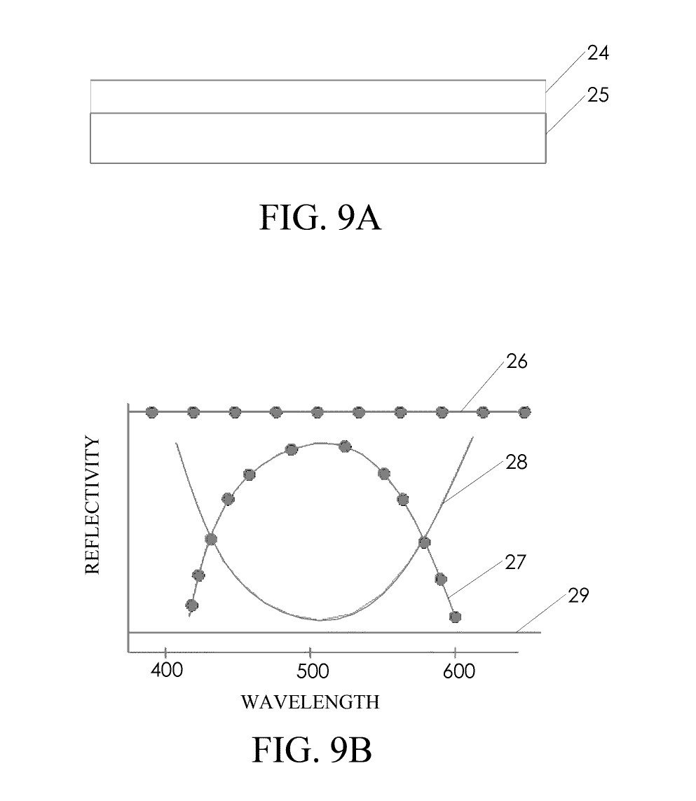

FIG. 9A is a cross-section view and 9B is a graph showing a LED with a polarization coating, which enhances the reflectivity of one polarization state of the LED.

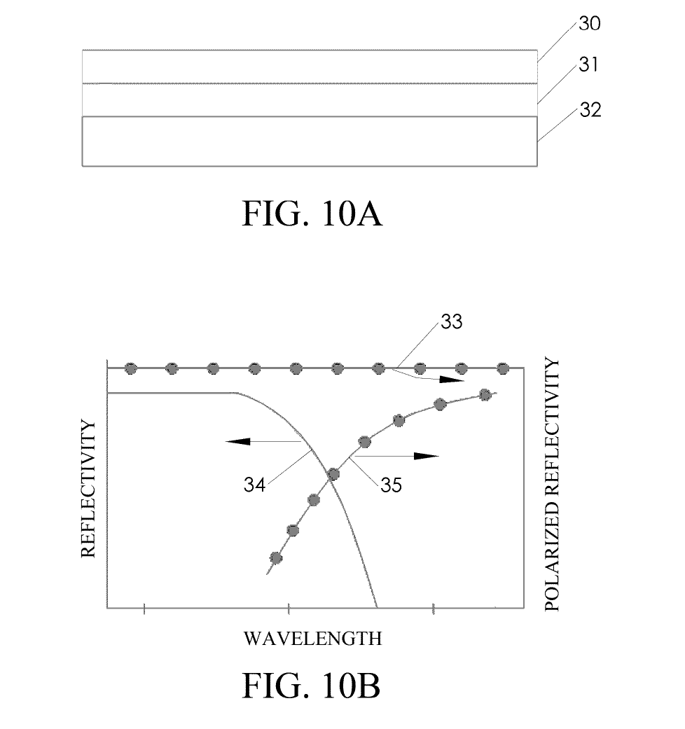

FIG. 10A is a cross-section view and 10B is a graph showing a LED with a wavelength dependent coating and polarization coating.

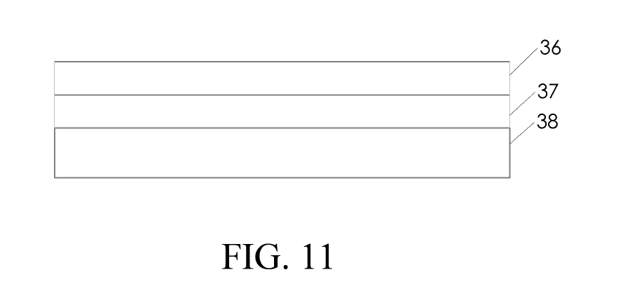

FIG. 11 shows a cross-section view of a LED with a wavelength dependent coating and retardation coating.

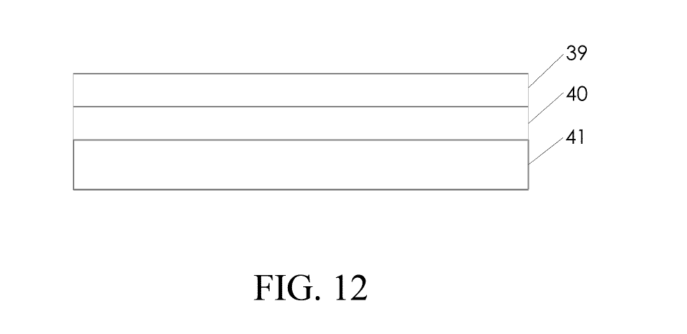

FIG. 12 shows a cross-section view of a LED with a polarization coating and retardation coating.

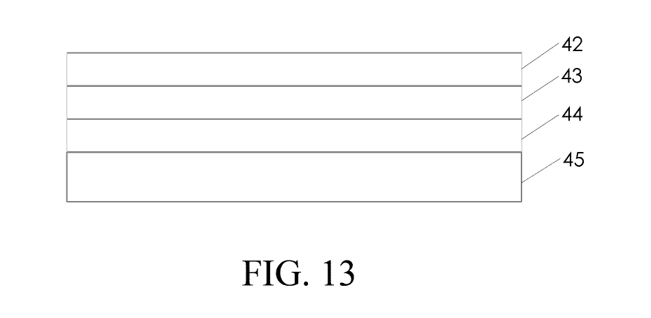

FIG. 13 shows a cross-section view of a LED with a wavelength dependent coating, polarization coating, and retardation coating.

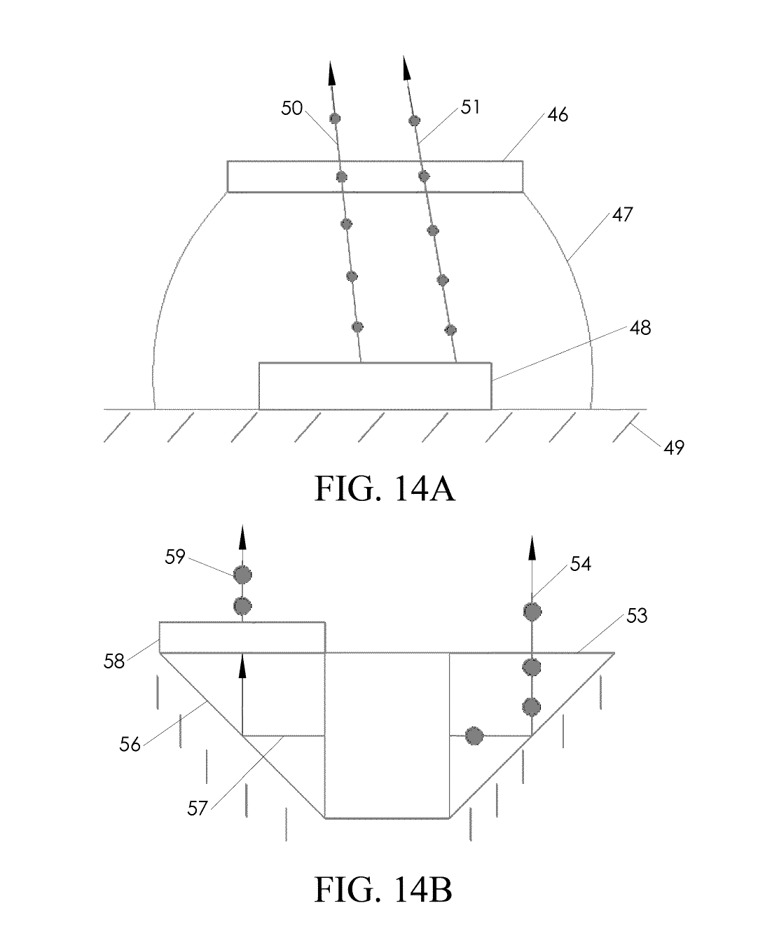

FIGS. 14A and 14B shows a cross-section view of a polarization reflective LED used in an optical system.

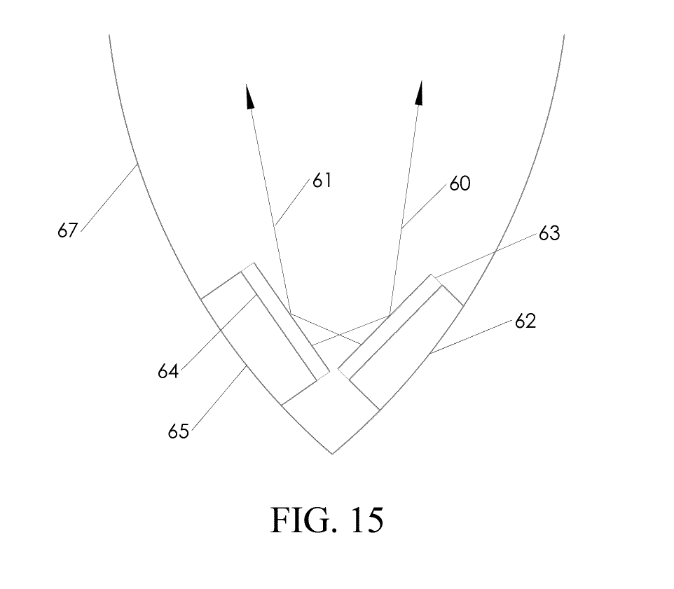

FIG. 15 shows a cross-section view of an optical system containing at least one wavelength reflective optical devices and at least one wavelength reflective wavelength conversion element.

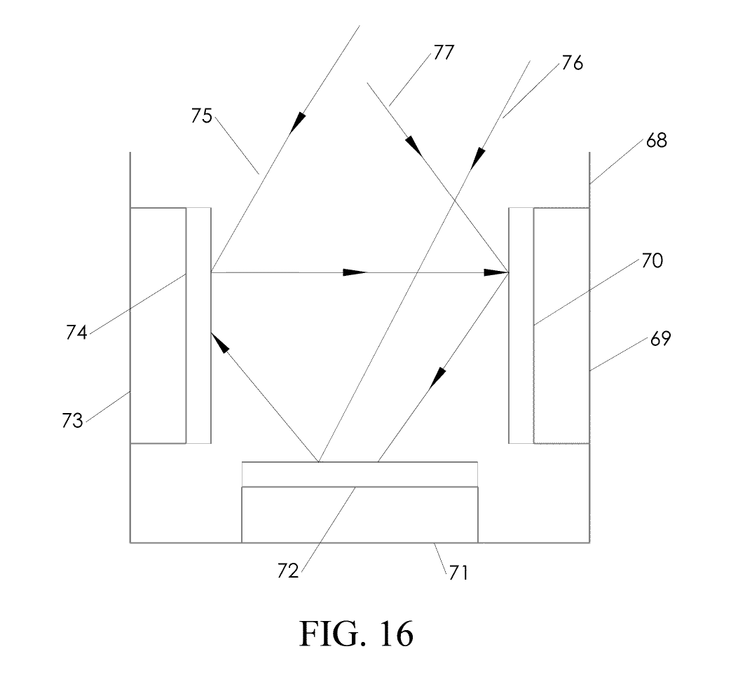

FIG. 16 shows a cross-section view of wavelength dependent solar cells in a cavity.

### DETAILED DESCRIPTION OF THE INVENTION

FIG. 1 shows the light recycling cavity output efficiency as a function of the reflectivity of a red LED in a mixed color RGB cavity. The efficiency of the cavity is highly dependent on the reflectivity of the red LED. The nature of ALGaN high brightness LEDs is that the LED has an inherent low reflectivity for blue and green wavelengths, typically less than 10% due to the bandgap properties of the material itself. The effect of this inherent low reflectivity for blue and green wavelengths significantly lowers the output efficiency of light emitted by the red and blue LEDs in a light recycling cavity.

In the preferred embodiment of this invention, the red LED is coated with a multi-layer thin film dichroic coating. Dichroic coatings are well known in the art and very high efficiency dichroic coatings are routinely deposited by physical vapor deposition and/or sputtering. Each LED contributes to the overall efficiency of the cavity, but the red LED in particular has a very strong effect on efficiency. Both 3 die and 4 die cavities are illustrated. As disclosed in previously mentioned patents, the ratio of emitting area to output aperture area determines both the efficiency and radiance of the source. If the reflectivity of the LEDs can be enhanced, the efficiency increases, regardless of the radiance enhancement of the optical system. Even further, it is an embodiment of this invention that enhanced reflectivity LEDs can be used in optical systems for enhanced color mixing, polarization reclamation, and combination of both with or without radiance enhancement. This technique can enhance solar conversion based on enhanced reflectivity solar cells.

FIG. 2 shows the spectral output of typical high brightness red, green, and blue LEDs. In this case, the blue and green LEDs are EZ1000 model LEDs manufactured by Cree and the red LED is an ALGaN LED manufactured by Epistar. Vertical and flip chip configurations are embodiments of this invention. Even more preferred is the use of epitaxial chips as previously disclosed in the patents. While visible LEDs are a preferred embodiment, the use of this technique in the UV and infrared spectrum is also envisioned. Alternate wavelength, polarization and phase dependent structures and coatings including but not limited to subwavelength optical elements, photonic crystals, gratings, wiregrid polarizers, birefringent layers and gradient index layers, can create these wavelength and/or polarization dependent coatings.

By applying dichroic coatings with transmittance and reflectivity as shown in FIG. 3 to these conventional LEDs, the recycling light cavity will be dramatically increased in efficiency.

In FIG. 3A, the transmittance/reflectance versus wavelength of the dichroic coating applied to the red LED is shown. In this case, the dichroic coating is a high pass filter transmitting the 620 nanometer wavelength of the red LED but reflecting the 480 nanometer wavelength and the 520 nanometer wavelength of the blue and green LEDs.

In FIG. 3B, the spectral transmittance/reflectance of the dichroic coating is shown applied to the blue LED. The coating forms a low pass filter passing the shorter wavelength emitted by the blue LED and reflecting the longer wavelength of the red and green LEDs.

In FIG. 3C, the transmittance/reflectance of the dichroic coating constituting a narrow band pass filter is applied to the green LED. Dichroic coatings are angular dependent as illustrated in the figures. The total integrated reflectance is a measure of reflectance over the entire solid angle of interest. The use of techniques as known in the art can reduce, enhance, and modify angular dependence of these coatings to affect the total integrated reflectance of the coating. The total integrated reflectance can be both wavelength and polarization dependent as well. Because the coatings are typically non-absorbing, the transmittance and reflectance can be directly related. If a coating has 95% reflectance at a particular angle and wavelength, it also has a transmittance of 5% at that particular angle and wavelength.

To apply these coatings to LEDs, the most economical method is during the manufacture of the LEDs themselves. In fact, typically a transparent coating passivation layer is applied to the LED as one of the last steps in the LED fabrication process. This passivation layer is a highly transparent layer, which protects the underlying gallium nitride or current spreading layers from moisture and the environment. Typically, this layer is silicon nitride. One preferred method would be to replace the passivation layer with a highly transparent dichroic coating, which would transmit the light emitted by the LED and reflect light of other wavelengths. This processing would be done prior to the wafer being scribed and cut or diced into individual LEDs.

If the manufacture of the LEDs is unable or unwilling to alter their process as described, then one must coat the dichroic coating on the individual LEDs. One method for coating individual LEDs is arraying and mounting the LEDs on a substrate for coating. However, in this process the metallic bond pads are protected from the coating process such that subsequent electrical connection could be made to the LEDs.

To be compatible with the high temperature coating process with low outgassing, the LEDs may be attached to a substrate with high temperature vacuum compatible adhesive. The bond pads can similarly be protected with a photoresist or dissolvable mask. Alternatively, the bond pads may be protected with a gold ball bump, which after coating can be sheared off prior to wirebonding. Another method is to assemble the LEDs into a light recycling cavity and attach the wirebond connections to the LEDs and then coat each colored LED by masking the alternate LEDs during the coating process.

In U.S. pending patent application Ser. No. 13/200,873 and U.S. Pat. No. 8,197,102, commonly assigned as the present patent application and herein incorporated by reference, light recycling cavities can be fabricated wherein the cavity is in a planar form with metallic hinges. This allows conventional LED die attach and wirebonding methods to be used. After the LEDs are attached and wirebond connections are made, the cavity is folded to form a light recycling cavity. After the folding, highly reflective end caps are added to complete the cavity.

In the process for coating the dichroic filter on each LED described above, multiple cavities would be fabricated and mounted and arrayed in a fixture in their unfolded condition. A template mask may then cover all but the particular colored LED that is being coated. In this way, no additional lithography steps are required to protect the metallic bond pads on the LEDs during the dichroic coating process. This method also has the advantage of enhancing reflectivity of the wirebonds and other parts of the cavity to the various emitted wavelengths of the LEDs.

The preferred light source of this invention comprises at least one light-emitting diode (LED). Preferred LEDs are inorganic light-emitting diodes and organic light-emitting diodes (OLEDs) that both emit light and reflect light. More preferred LEDs are inorganic light-emitting diodes due to their higher light output brightness.

An LED may be any LED that both emits light and reflects light. Examples of LEDs that both emit and reflect light include inorganic light-emitting diodes and OLEDs.

For purposes of simplifying the figures, each LED is illustrated in an identical manner and each LED has two elements, an emitting layer that emits light and a reflecting layer that reflects light. Note that typical LEDs are normally constructed with more than two elements, but for the purposes of simplifying the figures, the additional elements are not shown. Some of the embodiments of this invention may contain two or more LEDs. Although each LED is illustrated in an identical manner, it is within the scope of this invention that multiple LEDs in an embodiment may not all be identical. For example, if an embodiment of this invention has a plurality of LEDs, it is within the scope of this invention that some of the LEDs may be inorganic light-emitting diodes and some of the LEDs may be OLEDs. As a further example of an illumination system having multiple LEDs, if an embodiment of this invention has a plurality of LEDs, it is also within the scope of this invention that some of the LEDs may emit different colors of light. Example LED colors include, but are not limited to, wavelengths in the infrared, visible and ultraviolet regions of the optical spectrum. For example, one or more of the LEDs in a light-recycling envelope may emit red light, one or more of the LEDs may emit green light and one or more of the LEDs may emit blue light. If an embodiment, for example, contains LEDs that emit red, green and blue light, then the red, green and blue colors may be emitted concurrently to produce a single composite output color such as white light.

Preferred LEDs have at least one reflecting layer that reflects light incident upon the LED. The reflecting layer of the LED may be either a specular reflector or a diffuse reflector. Typically, the reflecting layer is a specular reflector. Preferably the reflectivity of the reflecting layer of the LED is at least 50%. More preferably, the reflectivity is at least 70%. Most preferably, the reflectivity R.sub.S is at least 90%.

Each LED is illustrated with an emitting layer facing the interior of the recycling light cavity and a reflecting layer positioned behind the emitting layer and adjacent to the inside surface of the recycling light cavity. In this configuration, light can be emitted from all surfaces of the emitting layer that are not in contact with the reflecting layer. It is also within the scope of this invention that a second reflecting layer can be placed on a portion of the surface of the emitting layer facing the interior of the light-recycling envelope. In the latter example, light can be emitted from the surfaces of the emitting layer that do not contact either reflecting layer. A second reflecting layer is especially important for some types of LEDs that have an electrical connection on the top surface of the emitting layer since the second reflecting layer can improve the overall reflectivity of the LED.

The total light-emitting area of the light source is area A.sub.S. If there is more than one LED within a single light-recycling envelope, the total light-emitting area A.sub.S of the light source is the total light-emitting area of all the LEDs in the light-recycling envelope.

The recycling light cavity of this invention is a light-reflecting element that at least partially encloses the light source. The recycling light cavity may be any three-dimensional surface that encloses an interior volume. For example, the surface of the recycling light cavity may be in the shape of a cube, a rectangular three-dimensional surface, a sphere, a spheroid, an ellipsoid, an arbitrary three-dimensional faceted surface or an arbitrary three-dimensional curved surface. Preferably the recycling light cavity has length, width and height dimensions such that no one dimension differs from the other two dimensions by more than a factor of five. In addition, preferably the three-dimensional shape of the recycling light cavity is a faceted surface with flat surface sides in order to facilitate the attachment of the LEDs to the inside surfaces of the cavity. In general, LEDs are usually flat and the manufacture of the recycling light cavity will be easier if the surfaces to which the LEDs are attached are also flat. Preferable three-dimensional shapes have a cross-section that is a square, a rectangle, a taper or a polygon.

The recycling light cavity reflects and recycles a portion of the light emitted by the light source back to the light source. Preferably the reflectivity R.sub.E of the inside surfaces of the light recycling light cavity is at least 50%. More preferably, the reflectivity R.sub.E is at least 70%. Most preferably, the reflectivity R.sub.E is at least 90%. Ideally, the reflectivity R.sub.E should be as close to 100% as possible in order to maximize the efficiency and exiting luminance of the illumination system.

The recycling light cavity may be fabricated from a bulk material that is intrinsically reflective. A bulk material that is intrinsically reflective may be a diffuse reflector or a specular reflector. Preferably a bulk material that is intrinsically reflective is a diffuse reflector. Diffuse reflectors reflect light rays in random directions and prevent reflected light from being trapped in cyclically repeating pathways. Specular reflectors reflect light rays such that the angle of reflection is equal to the angle of incidence.

Alternatively, if the recycling light cavity is not fabricated from an intrinsically reflective material, the interior surfaces of the recycling light cavity must be covered with a reflective coating. The reflective coating may be a specular reflector, a diffuse reflector or a diffuse reflector that is backed with a specular reflector. Diffuse reflectors typically need to be relatively thick (a few millimeters) in order to achieve high reflectivity. The thickness of a diffuse reflector needed to achieve high reflectivity can be reduced if a specular reflector is used as a backing to the diffuse reflector. Diffuse reflectors can be made that have very high reflectivity (for example, greater than 95% or greater than 98%).

Most specular reflective materials have reflectivity ranging from about 80% to about 98.5%.

The interior volume of the recycling light cavity that is not occupied by the light source may be occupied by a vacuum, may be filled with a light transmitting gas or may be filled or partially filled with a light-transmitting solid. Any gas or solid that fills or partially fills recycling light cavity should transmit light emitted by the light source.

The recycling light cavity has a light-output aperture. The light source and recycling light cavity direct at least a fraction of the light emitted by the light source out of the recycling light cavity through the light output aperture as incoherent light having a maximum exiting luminance. The total light output aperture area is area A.sub.O. An output aperture may have any shape including, but not limited to, a square, a rectangle, a polygon, a circle, an ellipse, an arbitrary faceted shape or an arbitrary curved shape.

For simplicity in FIG. 4, the recycling light cavity is assumed to have a cubical three-dimensional shape and a square cross-sectional shape. The shape is chosen for illustrative purposes and for ease of understanding of the descriptions. It should also be noted that the drawing is merely a representation of the structure; the actual and relative dimensions may be different.

As noted previously, the recycling light cavity may be any three-dimensional surface that encloses an interior volume. For example, the surface of the recycling light cavity may be in the shape of a cube, a rectangular three-dimensional surface, a sphere, a spheroid, an ellipsoid, a pyramid, an arbitrary three-dimensional faceted surface or an arbitrary three-dimensional curved surface. Preferably the three-dimensional shape of the recycling light cavity is a faceted surface with flat sides in order to facilitate the attachment of LEDs to the inside surfaces of the cavity. The only requirement for the three-dimensional shape of the recycling light cavity is that a fraction of any light emitted from an LED within the recycling light cavity must also exit from the light output aperture of the recycling light cavity within a finite number of reflections within the recycling light cavity, i.e. there are no reflective dead spots within the recycling light cavity where the light emitted from the LED will endlessly reflect without exiting the recycling light cavity through the light-output aperture.

The cross-section of the recycling light cavity may have any shape, both regular and irregular, depending on the shape of the three-dimensional surface. Other examples of possible cross-sectional shapes include a rectangle, a taper, a polygon, a circle, an ellipse, an arbitrary faceted shape or an arbitrary curved shape. Preferable cross-sectional shapes are a square, a rectangle or a polygon.

The inside surfaces of the recycling light cavity, except for the area covered by the LEDs and the area occupied by the light-output aperture, are light reflecting surfaces. The reflecting surfaces recycle a portion of the light emitted by the light source back to the light source. In order to achieve high light reflectivity, the recycling light cavity may be fabricated from a bulk material that is intrinsically reflective or the inside surfaces of the recycling light cavity may be covered with a reflective coating. The bulk material or the reflective coating may be a specular reflector, a diffuse reflector or a diffuse reflector that is backed with a specular reflector Preferably the reflectivity R.sub.E of the inside surfaces of the recycling light cavity that are not occupied by the LEDs and the light output aperture is at least 50%. More preferably, the reflectivity R.sub.E is at least 70%. Most preferably, the reflectivity R.sup.E is at least 90%. Ideally, the reflectivity R.sub.E should be as close to 100% as possible in order to maximize the efficiency and the maximum exiting luminance of the illumination system.

The square cross-sectional shape of the recycling light cavity has a first side containing the light-output aperture, a second side, a third side and a fourth side. The first side is opposite and parallel to the third side. The second side is opposite and parallel to the fourth side. The first side and third side are perpendicular to the second side and fourth side. The four sides of the recycling light cavity plus the two remaining sides (not shown in the cross-sectional view) of the six-sided cube form the interior of the recycling light cavity.

The light source for recycling light cavity are LEDs, which emits light of specified optical wavelengths. LEDs are positioned interior to the sides of the recycling light cavity and may be any inorganic light-emitting diode or an OLED.

Each LED has a reflecting layer and an emitting layer. The reflecting layer is adjacent to and interior to the side of the recycling light cavity while the emitting layer extends into the interior of the recycling light cavity. The reflecting layer may be a specular reflector or a diffuse reflector. In a typical inorganic light-emitting diode, the reflecting layer, if present, is usually a specular reflector. The light reflectivity of reflecting layer of the LED is R.sub.S. If the reflectivity varies across the area of the reflecting layer, the reflectivity R.sub.S is defined as the average reflectivity of the reflecting layer. The reflectivity R.sub.S of reflecting layer is preferably at least 50%. More preferably, the reflectivity R.sub.S of reflecting layer is at least 70%. Most preferably, the reflectivity R.sub.S of reflecting layer is at least 90%. Ideally, the reflectivity R.sub.S should be as close to 100% as possible in order to maximize the efficiency and the maximum exiting luminance of the recycling light cavity.

The total light-emitting area of the light source is area A.sub.S.

The light output aperture is in one side of the recycling light cavity. A fraction of the light emitted from the light source and reflected by the recycling light cavity exits the light-output aperture. As noted, the aperture may have any shape including, but not limited to, a square, a rectangle, a polygon, a circle, an ellipse, an arbitrary faceted shape or an arbitrary curved shape. The total light output aperture area is area A.sub.O.

In FIG. 4, a recycling light cavity is shown with a red LED 1, a green LED 4, and a blue LED 6. The recycling light cavity can have multiple red LEDs, multiple green LEDs, and/or multiple blue LEDs. For ease of understanding this invention, the light output area is not shown with this recycling light cavity. To enhance the reflectivity of the LEDs and the output efficiency of the light recycling cavity, dichroic coatings are applied to each of the LEDs. For the red LED 1, the dichroic coating 2 that has transmittance properties shown in FIG. 3A is applied. For the green LED 4, a dichroic coating 5 is applied having the transmittance properties shown in FIG. 3C and for the blue LED 6, a dichroic coating 7 having the transmittance properties shown in FIG. 3B is applied. Light emitted from the green LED shown by the ray 10 will be reflected from the dichroic coating 2 on the red LED 1 and will have much higher intensity exiting the cavity than if the coating was not there. The red LED 1 without the dichroic coating 2 has a reflectivity of less than 5% to the 520 nm wavelength of the light emitted by the green LED 4. However, with a suitable dichroic coating 2 on the red LED 1 the reflectivity can be as high as 90%. Similarly, light emitted by the blue LED 6 is enhanced in output intensity as the red LED 1 without the dichroic coating 2 has much lower reflectivity than with the dichroic coating 2.

As one can see from FIG. 4, the light from other LEDs in the cavity may be incident at very high angles. To achieve very high reflectance at oblique angles as well as normal incidence is very difficult and requires multiple coatings with different indexes of refraction. In addition, LEDs typically have their surface roughened to improve their extraction efficiency. This roughened surface is to defeat total internal reflection of light emanating from the multiple quantum wells inside the AlGaN and GaN devices. AlGaN has a refractive index of 3.5 and GaN has a refractive index of 2.5 within the visible spectrum. As such, a significant amount of the light generated within these high index regions is trapped due to internal reflection. This effect is overcome by roughening the surfaces to allow for enhanced extraction. This roughened surface can create a problem for achieving a high total integrated reflectivity with the dichroic coating. Many coatings are deposited using directional coaters, which can lead to non-uniform coating thicknesses. Non-directional coating techniques can be used to overcome this deficiency. Alternately, planarization techniques can achieve a high efficiency dichroic filter.

Embodied in the invention is a method of coating a high efficiency dichroic filter on a roughened LED surface. Referring to FIG. 5A, the LED wafer 12 contains extraction layer 11. Extraction layer 11 may include, but is not limited to, photonic crystal, subwavelength elements, microoptical elements and other extraction elements as known in the art.

In FIG. 5B, planarization layer 13 is deposited over extraction layer 11. Planarization layer 13 may include, but is not limited to, spin-on glasses, CVD glasses, off axis coatings, thick coating followed by CMP as well as other planarization methods known in the art. Planarization layer 13 may consist of SiO2, SiN, doped ZnO, ITO, AZO, GIZO, as well as other passivation and current spreading materials. Spin on glass is a preferred embodiment. The thickness of this layer may vary from several 100 angstroms to microns. It is preferred that the thickness of planarization layer 13 be substantially thicker than the roughness of extraction layer 11. The planarization layer 13 is then cured utilizing either a high temperate bake and/or more preferably with electron beam irradiation.

FIG. 5C depicts a high efficiency dichroic coating/filter 14 applied to the LED. Design of high efficiency dichroic coating/filter 14 is via modeling methods as known in the art. The planarization layer 13 can enable subwavelength, grating, photonic crystal and wire grid polarizers is also disclosed.

FIG. 6 depicts preferred embodiment based on electron beam curing to generated graded index layers. Shown in FIG. 6, the LED wafer is coated with a coating layer 16 over the LED. Coating layer 16 is subsequently cured either with a thermal and/or e-beam cure 15. Unlike typical dichroic coatings in which alternating layers of high index and low index materials are added to create a desired filter response, this technique can be used to create refractive index gradients 17 within a single layer or multiple layers. This effect is controlled by the density of electrons and energy level of those electrons. As previously disclosed in the patents, this technique can be used to vary the index of refraction significantly over a wide range for a given material. This is especially true in glasses and porous glasses as used in the semiconductor industry for passivation and low k dielectric applications. This process is described in U.S. Pat. Nos. 7,026,634 and 7,253,425 wherein the index of refraction can be continuously changed throughout the spin on glass layer. This process is less expensive, faster, and can create much higher efficiency dichroic coatings. Because gradient index profile is possible very high efficiency coatings can be constructed.

As mentioned previously, achieving very high reflection efficiency at oblique angles, as well as normal incidence, requires a continuously varied index of refraction in the film. Typically, this continuously varied index of refraction in the film is only approximated by coating multiple layers of varying thicknesses with different indexes of refraction. However, the e-beam process described achieves this high efficiency continuously varied index of refraction in one single process step. The spin on glass coated wafer is placed in the apparatus described in U.S. Pat. No. 7,253,425 and the accelerating voltage is varied along with the dose to create a continuously varied index of refraction within the film.

FIG. 7 depicts a conformal graded index coating on a semiconductor device. Using the technique described in the previous example, the index of refraction can be varied between surfaces 18 and 19. Depending on conditions, the index of refraction can be increased or decreased between surfaces 18 and 19. In addition, these graded index profiles can be spatially defined by selectively exposing different regions of the coating. In this manner, reflectivity and extraction efficiency can be varied over the surface of a given device.

FIG. 8 depicts a LED, which has a wavelength dependent reflectivity. Wavelength dependent coating 20 on LED 21 allows for high reflectivity for reflective wavelengths 23 substantially different than the emission wavelengths 22. This is the preferred embodiment of this invention. Because wavelength dependent coating 20 is substantially non-absorbing, the low reflectivity exhibited by wavelength dependent coating 20 for the emission wavelengths 22 translates into enhanced transmission or extraction efficiency relative to an uncoated device. As stated previously, wavelength dependent coating 20 is angularly dependent, as such reflectivity is defined by angle and wavelength with the total reflectivity being described by the total integrated reflectivity previously disclosed. A preferred embodiment of this invention is an LED with a wavelength dependent coating 20 in which the total integrated reflectivity for reflective wavelengths 23 is substantially higher than the total integrated reflectivity for emission wavelengths 22. The use of this LED in projectors, cellphones, displays, backlights, light sources, and general lighting is an embodiment of this invention.

FIG. 9 depicts a polarization enhanced LED. LED wafer 25 is coated with reflective polarizer 24. Reflective polarizer 24 may have substantially wavelength independent outputs 26 and 29 or have wavelength dependent outputs 27 and 28. In either case, one polarization state exhibits substantially higher reflectivity than the other polarization state. While the use of wire grid polarizers are a preferred embodiment for reflective polarizer 24, the use of liquid crystal, subwavelength, and other polarization dependent coatings for reflective polarizer 24 are also embodiments. Linear, circular, and elliptical polarization states are also embodiments of this invention. In particular, circularly polarizing layers for reflective polarizer 24 are preferred.

FIG. 10 depicts a combination polarization and wavelength dependent LED. LED 32 is coated with wavelength dependent coating 31 and reflective polarizer 30. Reflective polarizer 30 may have substantially wavelength independent 33 characteristics or have wavelength dependent 35 characteristics. This polarization effect is combined with wavelength dependent 34 characteristics. These techniques can be used in projectors containing DLP, LCOS, LCD and grating spatial light modulator.

FIG. 11 depicts an LED 38 with a wavelength dependent layer 37 and retardation layer 36. Retardation layer 36 may include, but is not limited to, anisotropic crystalline layers, oriented organic and inorganic films, and subwavelength elements as known in the art. Using this approach, incident light within a particular wavelength range can be rotated such that enhanced polarization mixing can occur within an optical cavity or element. The sequence of wavelength dependent layer 37 and retardation layer 36 as well as other layers described within this filing maybe alternated to enhance, reduce, and/or modify the extraction, reflectivity and/or both of the LED 38.

FIG. 12 depicts an LED 41 with a polarization layer 40 and retardation layer 39. Retardation layer 39 may include, but is not limited to, anisotropic crystalline layers, oriented organic and inorganic films, and subwavelength elements as known in the art. Using this approach, circular and elliptical polarization can be created. Alternately, incident light can be rotated such that enhanced polarization mixing can occur within an optical cavity or element. As stated earlier, the relative orientation of polarization layer 40 and retardation layer 39 may be changed based the particular application. Using this approach to enhance the efficiency of polarized light sources in cavities is a preferred embodiment of this invention. The use of polarization dependent, wavelength dependent, and/or retardation layers described in this disclosure on OLEDs and hybrid LEDs based on organic and inorganic layers are embodiments of this invention.

FIG. 13 depicts a LED 45 with wavelength dependent layer 44, a reflective polarizer 43 and retardation layer 42. This LED can be used in polarization based displays and light sources for inspection, 3D imaging, and security applications.

FIG. 14A depicts an optical system containing at least one polarization reflective LED 48 mounted onto heatsink 49. The optical cavity 47 restricts the output of at least one polarization reflective LED 48 such that some level of optical recycling occurs. Reflective polarizer 46 may be used to further enhance the amount of optical recycling such that at least a portion of optical ray 52 is returned to at least one polarization reflective LED 48. Some portion of optical ray 52 may be refracted or be reflected off optical cavity 47. Optical ray 52 may be rotated such that linearly polarized reflected ray 51, like linearly polarized unreflected ray 50, can be transmitted through reflective polarizer 46.

FIG. 14B depicts an epitaxial LED chip 55 with polarization reflective layers on both side of die. Polarized ray 54 is emitted from one side of epitaxial LED chip 55 while polarized ray 57 is emitted from the other side of epitaxial LED chip 55. If the polarization reflective layers are defined such that the two polarizations are substantial orthogonal, very high extraction efficiency can be realized from epitaxial LED chip 55. Turning elements 53 and 56 may include prisms, reflectors and collimators. Retardation film 58 may be used to rotate polarized ray 57 in to polarized ray 59, which has substantially the same polarization state as polarized ray 54. In this manner, a very compact and efficient polarized light source can be realized. The use of stacked epitaxial chips as previously disclosed by the authors with polarization reflective layers such that a compact RGB polarized light source is realized is an embodiment of this invention. These sources acne be used in projectors, light sources and displays.

FIG. 15 depicts an integrated directional light source containing at least two reflective LEDs. Blue LED 62 with blue transmitting/yellow reflecting layer 63 is used to excite wavelength conversion element 65 on which there is optionally a reflective layer 64. The enhanced reflectivity blue LED 62 to yellow light emitted by wavelength conversion element 65 leads to overall enhanced device efficiency. Alternately, reflective layer 64 can be used to selectively enhance, reduce, and modify coupling of excitation light from blue LED 62 into wavelength conversion element 65. This may be used to increase efficiency or change/tune color temperature. In this manner, the relative amount of energy in output rays 60 and 61 can be changed based on the characteristics of reflective layer 64 and blue transmitting/yellow reflecting layer 63. The integration of these elements within a directional optical element 67 is also an embodiment of this invention.

The wavelength conversion element is formed from wavelength conversion materials. The wavelength conversion materials absorb light in a first wavelength range and emit light in a second wavelength range, where the light of a second wavelength range has longer wavelengths than the light of a first wavelength range. The wavelength conversion materials may be, for example, phosphor materials or quantum dot materials. The wavelength conversion element may be formed from two or more different wavelength conversion materials. The wavelength conversion element may also include optically inert host materials for the wavelength conversion materials of phosphors or quantum dots. Any optically inert host material must be transparent to ultraviolet and visible light.

Phosphor materials are typically optical inorganic materials doped with ions of lanthanide (rare earth) elements or, alternatively, ions such as chromium, titanium, vanadium, cobalt or neodymium. The lanthanide elements are lanthanum, cerium, praseodymium, neodymium, promethium, samarium, europium, gadolinium, terbium, dysprosium, holmium, erbium, thulium, ytterbium and lutetium. Optical inorganic materials include, but are not limited to, sapphire (Al.sub.2O.sub.3), gallium arsenide (GaAs), beryllium aluminum oxide (BeAl.sub.2O.sub.4), magnesium fluoride (MgF.sub.2), indium phosphide (InP), gallium phosphide (GaP), yttrium aluminum garnet (YAG or Y.sub.3Al.sub.5O.sub.12), terbium-containing garnet, yttrium-aluminum-lanthanide oxide compounds, yttrium-aluminum-lanthanide-gallium oxide compounds, yttrium oxide (Y.sub.2O.sub.3), calcium or strontium or barium halophosphates (Ca,Sr,Ba).sub.5(PO.sub.4).sub.3(Cl,F), the compound CeMgAl.sub.11O.sub.19, lanthanum phosphate (LaPO.sub.4), lanthanide pentaborate materials alanthanide)(Mg, Zn)B.sub.5O.sub.10), the compound BaMgAl.sub.10O.sub.17, the compound SrGa.sub.2S.sub.4, the compounds (Sr,Mg,Ca,Ba)(Ga,Al,In).sub.2S.sub.4, the compound SrS, the compound ZnS and nitridosilicate. There are several exemplary phosphors that can be excited at 250 nm or thereabouts. An exemplary red emitting phosphor is Y.sub.2O.sub.3:Eu.sup.3+. An exemplary yellow emitting phosphor is YAG:Ce.sup.3+. Exemplary green emitting phosphors include CeMgAl.sub.11O.sub.19:Tb.sup.3+, ((lanthanide)PO.sub.4:Ce.sup.3+, Tb.sup.3+) and GdMgB.sub.5O.sub.10:Ce.sup.3+, Tb.sup.3+. Exemplary blue emitting phosphors are BaMgAl.sub.10O.sub.17:Eu.sup.2+ and (Sr,Ba,Ca).sub.5(PO.sub.4).sub.3Cl:Eu.sup.2+. For longer wavelength LED excitation in the 400-450 nm wavelength region or thereabouts, exemplary optical inorganic materials include yttrium aluminum garnet (YAG or Y.sub.3Al.sub.5O.sub.12), terbium-containing garnet, yttrium oxide (Y.sub.2O.sub.3), YVO.sub.4, SrGa.sub.2S.sub.4, (Sr,Mg,Ca,Ba)(Ga,Al,In).sub.2S.sub.4, SrS, and nitridosilicate. Exemplary phosphors for LED excitation in the 400-450 nm wavelength region include YAG:Ce.sup.3+, YAG:Ho.sup.3+, YAG:Pr.sup.3+, YAG:Tb.sup.3+, YAG:Cr.sup.3+, YAG:Cr.sup.4+, SrGa.sub.2S.sub.4:Eu.sup.2+, SrGa.sub.2S.sub.4:Ce.sup.3+, SrS:Eu.sup.2+ and nitridosilicates doped with Eu.sup.2+.

Luminescent materials based on ZnO and its alloys with Mg, Cd, Al are preferred. More preferred are doped luminescent materials of ZnO and its alloys with Mg, Cd, Al which contain rare earths, Bi, Li, Zn, as well as other luminescent dopants. Even more preferred is the use of luminescent elements which are also electrically conductive, such a rare earth doped AlZnO, InZnO, GaZnO, InGaZnO, and other transparent conductive oxides of indium, tin, zinc, cadmium, aluminum, and gallium. Other phosphor materials not listed here are also within the scope of this invention.

Quantum dot materials are small particles of inorganic semiconductors having particle sizes less than about 30 nanometers. Exemplary quantum dot materials include, but are not limited to, small particles of CdS, CdSe, ZnSe, InAs, GaAs and GaN. Quantum dot materials can absorb light at first wavelength and then emit light at a second wavelength, where the second wavelength is longer than the first wavelength. The wavelength of the emitted light depends on the particle size, the particle surface properties, and the inorganic semiconductor material.

The transparent and optically inert host materials are especially useful to spatially separate quantum dots. Host materials include polymer materials and inorganic materials. The polymer materials include, but are not limited to, acrylates, polystyrene, polycarbonate, fluoroacrylates, chlorofluoroacrylates, perfluoroacrylates, fluorophosphinate polymers, fluorinated polyimides, polytetrafluoroethylene, fluorosilicones, sol-gels, epoxies, thermoplastics, thermosetting plastics and silicones. Fluorinated polymers are especially useful at ultraviolet wavelengths less than 400 nanometers and infrared wavelengths greater than 700 nanometers owing to their low light absorption in those wavelength ranges. Exemplary inorganic materials include, but are not limited to, silicon dioxide, optical glasses and chalcogenide glasses.

A wavelength conversion layer can be formed by depositing phosphor materials onto an inert substrate using any one of a variety of techniques or formed by extrusion. The techniques include, but are not limited to, chemical vapor deposition (CVD), metal-organic chemical vapor deposition (MOCVD), sputtering, electron beam evaporation, laser deposition, sol-gel deposition, molecular beam epitaxy (MBE), liquid phase epitaxy (LPE), spin coating, slip casting, doctor blading and tape casting. Preferred techniques include slip casting, doctor blading, tape casting, CVD, MOCVD and sputtering. More preferred techniques include slip casting and tape casting. When the wavelength conversion layer is formed from quantum dot materials and inert host materials, deposition techniques include spin coating, slip casting, doctor blading, tape casting, self assembly, lithography, and nanoimprinting.

The solid state light source is typically a light emitting diode. Light emitting diodes (LEDs) can be fabricated by epitaxially growing multiple layers of semiconductors on a growth substrate. Inorganic light-emitting diodes can be fabricated from GaN-based semiconductor materials containing gallium nitride (GaN), aluminum nitride (AlN), aluminum gallium nitride (AlGaN), indium nitride (InN), indium gallium nitride (InGaN) and aluminum indium gallium nitride (AlInGaN). Other appropriate materials for LEDs include, for example, aluminum gallium indium phosphide (AlGaInP), gallium arsenide (GaAs), indium gallium arsenide (InGaAs), indium gallium arsenide phosphide (InGaAsP), diamond or zinc oxide (ZnO).

Especially important LEDs for this invention are GaN-based LEDs that emit light in the ultraviolet, blue, cyan and green regions of the optical spectrum. The growth substrate for GaN-based LEDs is typically sapphire (Al.sub.2O.sub.3), silicon carbide (SiC), bulk gallium nitride or bulk aluminum nitride.

A solid state light source can be a blue or ultraviolet emitting LED used in conjunction with one or more wavelength conversion materials such as phosphors or quantum dots that convert at least some of the blue or ultraviolet light to other wavelengths. For example, combining a yellow phosphor with a blue emitting LED can result in a white light source. The yellow phosphor converts a portion of the blue light into yellow light. Another portion of the blue light bypasses the yellow phosphor. The combination of blue and yellow light appears white to the human eye. Alternatively, combining a green phosphor and a red phosphor with a blue LED can also form a white light source. The green phosphor converts a first portion of the blue light into green light. The red phosphor converts a second portion of the blue light into green light. A third portion of the blue light bypasses the green and red phosphors. The combination of blue, green and red light appears white to the human eye. A third way to produce a white light source is to combine blue, green and red phosphors with an ultraviolet LED. The blue, green and red phosphors convert portions of the ultraviolet light into, respectively, blue, green and red light. The combination of the blue, green and red light appears white to the human eye.

The light source of the present invention is a solid wavelength conversion element on a solid state light source. The wavelength conversion element can be a luminescent element. The solid state light source can be a light emitting diode having an active region of, for example, a p-n homojunction, a p-n heterojunction, a double heterojunction, a single quantum well or a multiple quantum well of the appropriate semiconductor material for the LED. The solid state light source can also be a laser diode, a vertical cavity surface emitting laser (VCSEL), an edge-emitting light emitting diode (EELED), or an organic light emitting diode (OLED).

FIG. 16 depicts a solar cavity with wavelength dependent coatings. The solar spectrum is very wide relative to efficiency solar cell device performance. As such, multi junction solar cells are typically used to cover a wider range of the available wavelength. However a similar problem exists to what has been addressed in this disclosure. Si solar cells are efficient red absorbers but absorb strong in the blues and greens. Using the same technique described previously, solar cavities can be constructed which enhance overall conversion efficiency. In addition, concentrated solar cells offer enhanced performance due to higher flux levels. However, when the highly collimated incident solar radiance is concentrated, the solid angle of the rays must increase. The result is essentially the same optical situation as the case seen in light emitting cavities. Light is received through a light input aperture by the solar cells in the cavity, unlike light being emitted by the light emitting diodes in the light recycling cavity. Wavelength dependent coatings can be used to wavelength selectively direct concentrated light from the sun onto the appropriate solar cell within an optical recycling cavity. Typically, three junction solar cells are used based on a cost and efficiency tradeoff. In this example, a silicon, GaAs, and GaN solar cell is depicted. Si solar cell 69 is coated with visible reflecting layer 70. GaAs solar cell 71 is coated with blue/IR reflecting coating 72, and GaN solar cell 73 is coated with green, yellow, red, IR reflecting coating 74. Yellow incident ray 77 reflects off coating 70 and is absorbed in GaAs solar cell 71. Blue incident ray 76 reflects off coating 72 and is absorbed in GaN solar cell 73. Lastly IR incident ray 75 is reflected off coating 74 and is absorbed in Si solar cell 69. Cavity 68 allows for multiple reflection and opportunities for incident rays to hit the appropriate solar cell. The use of diffusive elements on the surface of coatings, solar cells, and within the cavity 68 to enhance mixing is an embodiment of this invention.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative, not limiting. Various changes may be made without departing from the spirit and scope of the invention as defined in the following claims.

1. A recycling light cavity comprising
multiple reflective surfaces enclosing a cavity, a light output aperture in at least one of said multiple reflective surfaces;
a first LED emitting light of a first wavelength;
a second LED emitting light of a second wavelength, said second wavelength being different from said first wavelength;
said first LED emitting light of said first wavelength through said light output aperture or emitting light of said first wavelength reflected from at least one of said multiple reflective surfaces or reflected from said second LED;
said second LED emitting light of said second wavelength through said light output aperture or emitting light of said second wavelength reflected from at least one of said multiple reflective surfaces or reflected from said first LED;
said first LED having a first coating to enhance reflectivity of said second wavelength; and
said second LED having a second coating to enhance reflectivity of said first wavelength.

2. The recycling light cavity of claim 1 wherein said first coating and said second coating are dichroic filters.

3. The recycling light cavity of claim 1 further comprising
a third LED emitting light of a third wavelength, said third wavelength being different from said first wavelength and said second wavelength;
said third LED emitting light of said third wavelength through said light output aperture or emitting light of said third wavelength reflected from at least one of said multiple reflective surfaces or reflected from said first LED or said second LED;
said first LED or said second LED reflecting light of said third wavelength;
said first LED having a first coating to enhance reflectivity of said second wavelength and/or said third wavelength; and
said second LED having a second coating to enhance reflectivity of said first wavelength and/or said third wavelength;
said third LED having a third coating to enhance reflectivity of said first wavelength and/or said second wavelength.

4. The recycling light cavity of claim 3 wherein said first coating, said second coating and said third coating are dichroic filters.

5. The recycling light cavity of claim 3 wherein said first wavelength is in the red range, said second wavelength is in the green range and said third wavelength is in the blue range.

6. The recycling light cavity of claim 4 wherein
a first dichroic filter coating on said first LED transmits a substantial portion of said light of said first wavelength emitted from said first LED and reflects a substantial portion of said light of said second wavelength and said light of said third wavelength,
a second dichroic filter coating on said second LED transmits a substantial portion of said light of said second wavelength emitted from said second LED and reflects a substantial portion of said light of said first wavelength and said light of said third wavelength, and
a third dichroic filter coating on said third LED transmits a substantial portion of said light of said third wavelength emitted from said third LED and reflects a substantial portion of said light of said second wavelength and said light of said first wavelength.

7. The recycling light cavity of claim 3 wherein said first coating, said second coating and said third coating are at least one of the following elements: a polarization coating, a wavelength dependent coating, and a retardation coating.

8. The recycling light cavity of claim 4 wherein said dichroic filters are formed by planarizing the surface of said first LED, said second LED and said third LED with a spin-on glass, curing said spin-on glass, applying said dichroic, and optionally inducing spatially graded index of refraction via electron beam exposure of said spin-on glass.

9. The recycling light cavity of claim 4 wherein the surfaces of said first LED, said second LED and said third LED have light extraction elements, said light extraction elements being formed by roughening the surface of the LED wafer, coating said roughened surface with a spin-on glass, and inducing spatially graded index of refraction via electron beam exposure of said spin-on glass.

10. A recycling optical cavity comprising
multiple reflective surfaces enclosing a cavity, a light input aperture in at least one of said multiple reflective surfaces for transmitting sunlight into said cavity;
a first solar cell light absorbing sunlight of a first wavelength; said first solar cell reflecting light of other wavelengths than said first wavelength;
a second solar cell light absorbing sunlight of a second wavelength, said second wavelength being different from said first wavelength, and said second solar cell reflecting light of other wavelengths than said second wavelength;
said first solar cell having a first coating to enhance reflectivity of other wavelengths than said first wavelength; and
said second solar cell having a second coating to enhance reflectivity of other wavelengths than said second wavelength.

11. The recycling optical cavity of claim 10 wherein said first coating and said second coating are dichroic filters
